(19) United States
(12) Patent Application Publication
(10) Pub. No.: US 2007/0016845 A1
(43) Pub. Date: Jan. 18, 2007

(54) Generation of serial routing rules for an electronic document using reverse cone of logic

(75) Inventor: STEVE YANKOVICH, SAN JOSE, CA (US)

Correspondence Address: PATENTRY, P.O. BOX 151616, SAN RAFAEL, CA, 94915-1616, US

(73) Assignee: MOVARIS, INC, SAN JOSE, CA (US)

(21) Appl. No.: 11/428,358

(22) Filed: Jun. 30, 2006

Related U.S. Application Data
(63) Continuation-in-part of application No. 10/097,513, filed on Mar. 12, 2002, now Pat. No. 7,103,835.

(51) Int. Cl. G06F 17/00

(52) U.S. Cl. 715/500; 715/505

(57) ABSTRACT

Creating a serial self-routing rule within an electronic document using programmatic means that evaluate a reverse cone of logic from final process backward through intermediate processes to initial data entry.

### CROSS-REFERENCE TO RELATED APPLICATIONS

This application is a continuation-in-part of pending commonly assigned U.S. non-provisional utility application Ser. No. 10/097,513 file date Mar. 12, 2002 by Steve Yankovich et al, notice of allowance mailed May 23, 2006. The subject matter of the foregoing is incorporated herein by reference in their entirety.

### BACKGROUND

In workflow rule construction the conventional approach uses a left to right construction. Consider that a workflow consists of inputs (call them i1, i2, i3, . . . in) and then rule based destinations (call them d1, d2, d3). Conventional approaches consider an analogy similar to electronic circuitry when defining rules. They consider the inputs on the left and the outputs (destinations on the right). So in the conventional approach two rules might look like:
Rule 1: (i1=true) & ((i2=true) or (i3=true)) then d1=true
Rule 2: (i4=true) or ((i1=true) & ((i2=true) or (i3=true))) then d2=true

Note that Rule 2 contains a duplicate of Rule 1 (bold) within it, but yet defines that the workflow should go to destination 2. But if the goal was a serial workflow a system cannot assign both destination 1 and 2 at the same time, rules 1 and 2 are in conflict. If the goal was to define a parallel workflow how would know that the goal was for the parallel destinations to be d1 and d2 and not an error in serial routing? It is for these reasons that these approaches when implemented in systems, further require the development and testing of simulators and debuggers adding to the cost, training, and complexity.

This it can be appreciated that what is needed is a system which eliminates the need for simulators and debuggers to evaluate the routing of a document so that a document cannot be inadvertently directed to two signatories which may result in contradictory decisions or deadlock. And it can be appreciated that signature approval is only one embodiment of a process which can be routed and initiated based on rules operating on logical conditions.

### SUMMARY OF THE INVENTION

In this invention the Boolean equation, or the operators used on the inputs, do not define the invention. The key is the direction of construction. This invention describes a right to left, or in other words drives the construction of a serial routing rule from the destination. In this approach the method drives back to all inputs such that the rules constructed for other destinations cannot be partially contained in another rule. This approach forces the rule to consider every input that can affect it. The rules are never in conflict and are correct by construction.
Rule 1: d1=true if ((i1=true) & ((i2=true) or (i3=true))) or i4=false
Rule 2: d2=true if (i4=true) or ((i1=true) & ((i2=true) or (i3=true)))

In an embodiment, this reverse rule construction is applied to a business form where text and number are the inputs and required signatures (person roles) are the destinations. The approach of starting with a potential required signature (destination) and considering all data and number inputs that affect if it is required provides a more easily understood rule construction approach for the user. The conventional approach of input to destination (left to right) is an embodiment of state machine rule construction. These are not easily understood by people and so are prone to error and are prone to conflict as illustrated.

### DETAILED DESCRIPTION

Building a reverse cone of logic comprises
inserting a trigger data field into an electronic document that triggers a final process,
identifying at least one last prerequisite data field that immediately arms the trigger data field,
modifying attributes of the trigger data field in at least one of the following, visibility, editability;
associating a precursor process to the last prerequisite data field, and
routing the electronic document to initiate the precursor process.

In a computer system, the present invention for controlling the serial self-routing of electronic document, is a method residing in a computer readable medium comprising the computer implemented steps of creating an electronic document; building a reverse cone of logic from each possible process for an electronic document to every data field that would affect it.

The simplest process could be making an approval signature field of a executive visible and editable. A prerequisite could be obtaining a department manager's approval. A prerequisite of that could be entering data within acceptable ranges.

The executive signature could be the trigger data field that triggers a final process,

The routing could be made conditional by selecting a plurality of data fields; grouping the data fields with at least one boolean functions into a boolean group; creating at least one programmatic element equivalent to the boolean group; and inserting the programmatic element into the electronic document.

In use, the document itself determines if a process is required given the values of the data fields; and routes the electronic document to the indicated process.

A computer program product tangibly embodies on a computer readable medium encoding the present invention as instructions executable by a processor, the instructions comprising creating an electronic document; building a reverse cone of logic from a process for an electronic document backward to every data field that would affect it; wherein the process comprises at least one of: affixing a routing approval signature, changing a graphical display, controlling visibility of a field, initiating another process, triggering an event, requiring data entry, prompting an interactive response, enabling the attachment of another document, querying a database, and routing the document to a certain user.

Starting from the final trigger of the document and working backward to the inputs eliminates a sources of confusion and errors and enables a document correct by construction through building a reverse cone of logic. The reverse cone works from right to left by inserting a trigger data field into an electronic document that triggers a final process, identifying at least one last prerequisite data field that immediately arms the trigger data field, modifying attributes of the trigger data field in at least one of the following, visibility, editability; associating a precursor process to the last prerequisite data field, and creating programmatic elements which evaluate the prerequisite data fields; and inserting the programmatic elements into the electronic document; and routing the electronic document to the process by evaluating the data fields.

The present invention is embodied in a system for processing electronic documents, comprising a memory unit that accesses stored data files, the data files comprising static document content and editable inputs, and a processor that is in communication with the memory unit; wherein the processor is adapted to perform the steps following: creating an electronic document; building a reverse cone of logic from a process for an electronic document to every input that would affect it; wherein the process could be affixing a routing approval signature, changing a graphical display, controlling visibility of a field, initiating another process, triggering an event, requiring data entry, prompting an interactive response, enabling the attachment of another document, querying a database, or routing the document to a certain user.

The key to an efficient and robust system is for each document, building a reverse cone of logic by inserting a trigger data field into an electronic document that triggers a final process, identifying at least one last prerequisite data field that immediately arms the trigger data field, modifying attributes of the trigger data field so as to enable visibility, and editability; associating a precursor process to the last prerequisite data field, and repeating the process of backing through a series of precursor processes until the document has a serial routing from its initially entered data fields. Then creating programmatic elements which evaluate the prerequisite data fields; and inserting the programmatic elements into the electronic document complete the general template of the document. When a user begins to enter data into the data fields, the system begins routing the electronic document to the process by evaluating the data fields. Obviously the system further comprising an input device for controlling the processor and further comprising a display device for viewing processing results of the processor.

The present invention creates a serial routing rule for an electronic document by building a reverse cone of logic from a process for an electronic document to every data field on the electronic document that potentially triggers the process. In embodiments the process could be simply affixing a routing approval signature, changing a graphical display, controlling visibility of a field, initiating another process, triggering an event, requiring data entry, prompting an interactive response, enabling the attachment of another document, querying a database, or routing the document to a certain user.

In a conventional workflow rule construction system, the rules are developed by first considering at least one of the data fields on the document and determining at least one destination for each possible value of at least one data field. These rules are susceptible to the document being routed to more than one destination in parallel and it can be considered a feature by the developers of conventional workflow rule systems. It is seldom the case that parallel processing is intended or desirable. In practice, there are prerequisites, and priorities that make a forced sequential process more efficient. For example, if General Counsel approves and a General Manager disapproves, whose time has been wasted? The present invention addresses this short coming by forcing the scheduler to evaluate one rule at a time and sequentially routing the workflow. The present invention comprises a method of constructing a rule for workflow routing of a document comprising firstly identifying each data field on a document that represents a potential destination, secondly, identifying each conditional destination which may be skipped depending on the value of input data fields on a document, thirdly serializing the destinations according to the logical sequence of processes, fourthly, selecting a first conditional destination, and fifthly, constructing a rule to route the document to the first conditional destination if true comprising at least one of the following: a data field, a value, a boolean operator, an equality operator, an inequality operator, a logic expression, and combination of values, operators, and data fields.

In an embodiment, the construction of the rule is done by selecting at least one data field from a list, selecting at least one mathematical or logic operator from a list, selecting at least one of a text, number, and logic value, and optionally grouping related expressions for evaluation by a bounding box.

What is claimed is:

1. In a computer system, a method for controlling the serial routing of electronic document, said method residing in a computer readable medium comprising the computer implemented steps of
creating an electronic document;
building a reverse cone of logic from each possible process for an electronic document to every data field that would affect it; wherein a process comprises at least one of methods selected from the following group:
affixing a routing approval signature,
changing a graphical display,
controlling visibility of a field,
initiating another process,
triggering an event,
requiring data entry,
prompting an interactive response,
enabling the attachment of another document,
querying a database, and
routing the document to a certain user, and
wherein building a reverse cone of logic comprises
inserting a trigger data field into an electronic document that triggers a final process,
identifying at least one last prerequisite data field that immediately arms the trigger data field,
modifying attributes of the trigger data field in at least one of the following, visibility, editability;
associating a precursor process to the last prerequisite data field, and
routing the electronic document to initiate the precursor process.

2. The method of claim 1 further comprising
selecting a plurality of data fields;
grouping the data fields with at least one boolean function into a boolean group;
creating at least one programmatic element equivalent to the boolean group; and
inserting the programmatic element into the electronic document.

3. The method of claim 1 further comprising
determining if a process is required given the values of the data fields; and
routing the electronic document to the process if required.

4. A computer program product tangibly embodied on a computer readable medium encoding the method of claim 1 as instructions executable by a processor, the instructions comprising
creating an electronic document;
building a reverse cone of logic from a process for an electronic document backward to every data field that would affect it; wherein the process comprises at least one of:
affixing a routing approval signature,
changing a graphical display,
controlling visibility of a field,
initiating another process,
triggering an event,
requiring data entry,
prompting an interactive response,
enabling the attachment of another document,
querying a database, and
routing the document to a certain user, and
wherein building a reverse cone of logic comprises
inserting a trigger data field into an electronic document that triggers a final process,
identifying at least one last prerequisite data field that immediately arms the trigger data field,
modifying attributes of the trigger data field in at least one of the following, visibility, editability;
associating a precursor process to the last prerequisite data field, and
creating programmatic elements which evaluate the prerequisite data fields; and inserting the programmatic elements into the electronic document; and routing the electronic document to the process by evaluating the data fields.

5. A system for processing electronic documents, comprising:
a memory unit that accesses stored data files, the data files comprising static document content and editable inputs, and a processor that is in communication with the memory unit; wherein the processor is adapted to perform the following:
creating an electronic document;
building a reverse cone of logic from a process for an electronic document to every input that would affect it; wherein the process comprises at least one of:
affixing a routing approval signature,
changing a graphical display,
controlling visibility of a field,
initiating another process,
triggering an event,
requiring data entry,
prompting an interactive response,
enabling the attachment of another document,
querying a database, and
routing the document to a certain user;
wherein building a reverse cone of logic comprises
inserting a trigger data field into an electronic document that triggers a final process,
identifying at least one last prerequisite data field that immediately arms the trigger data field,
modifying attributes of the trigger data field in at least one of the following, visibility, editability;
associating a precursor process to the last prerequisite data field, and
creating programmatic elements which evaluate the prerequisite data fields; and inserting the programmatic elements into the electronic document; and routing the electronic document to the process by evaluating the data fields;
the system further comprising an input device for controlling the processor and further comprising a display device for viewing processing results of the processor.

6. A method for creating a serial self-routing rule for an electronic document comprising
building a reverse cone of logic from a process for an electronic document to every data field on the electronic document that potentially triggers the process; wherein the process comprises at least one of:
affixing a routing approval signature,
changing a graphical display,
controlling visibility of a field,
initiating another process,
triggering an event,
requiring data entry,
prompting an interactive response,
enabling the attachment of another document,
querying a database, and
routing the document to a certain user;
wherein building a reverse cone of logic comprises
inserting a trigger data field into an electronic document that triggers a final process,
identifying at least one last prerequisite data field that immediately arms the trigger data field,
modifying attributes of the trigger data field in at least one of the following, visibility, editability;
associating a precursor process to the last prerequisite data field, and
routing the electronic document to initiate the precursor process.

7. The method of claim 6 further comprising
selecting a plurality of data fields;
grouping the data fields with at least one boolean functions into a boolean group;
creating at least one programmatic element equivalent to the boolean group; and
inserting the programmatic element into the electronic document.

8. The method of claim 6 further comprising determining if a process is required given the values of the data fields; and routing the electronic document to the process if required.

9. The method of constructing a rule for serial workflow routing of a document comprising firstly identifying each data field on a document that represents a potential destination, secondly, identifying each conditional destination which may be skipped depending on the value of input data fields on a document, thirdly serializing the destinations according to the logical sequence of processes, fourthly, selecting a first conditional destination, and fifthly, constructing a rule to route the document to the first conditional destination if true comprising at least one of the following: a data field, a value, a boolean operator, an equality operator, an inequality operator, a logic expression, and combination of values, operators, and data fields.
